(19) United States
(12) Patent Application Publication
(10) Pub. No.: US 2007/0098214 A1
(43) Pub. Date: May 3, 2007

(54) IMAGE PROCESSING APPARATUS, IMAGE PROCESSING METHOD, AND STORAGE MEDIUM

(75) Inventor: Keiichi IWAMURA, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/559,586

(22) Filed: Nov. 14, 2006

Related U.S. Application Data
(62) Division of application No. 09/867,432, filed on May 31, 2001.

(30) Foreign Application Priority Data
May 31, 2000 (JP) 2000-163372

(51) Int. Cl. G06K 9/00; G06K 9/36

(52) U.S. Cl. 382/100; 382/276

(57) ABSTRACT

A digital watermark mark which is robust against alliance and average value attacks is embedded in data, and original data is protected from being tampered with. Image quality that may be obtained by an attacker by, e.g., an alliance attack is determined. In this case, LL3 is determined to be that image quality. A portion to be modified of high-image quality portions is determined. In this case, HL1 is determined as a high-image quality portion to be modified, and is entirely shifted rightward by 1 bit. Hence, prepared block images undergo wavelet transformation to be decomposed into frequency components, and HL1 as the selected high-image quality portion is modified. Upon completion of the aforementioned modification process, this block undergoes inverse wavelet transformation to reclaim the block image.

### FIELD OF THE INVENTION

The present invention relates to an image processing apparatus and method for embedding a digital watermark in an image, and a storage medium.

### BACKGROUND OF THE INVENTION

In recent years, computers and networks have developed remarkably, and various kinds of information such as text data, image data, audio data, and the like are processed in a computer and network.

In a current environment, since such data is digital data, a copy of data having the same quality can be easily formed. In order to protect copyrights of such data, a process for embedding copyright information or user information in image data and audio data as a digital watermark is often done. Note that digital watermarking is a technique for secretly embedding information in image or audio data by executing predetermined process of such data.

By extracting the digital watermark from data, copyright information, user information, identification information, and the like can be obtained, and illegal copies can be traced.

The first condition required for digital watermarking is that embedded information is imperceptible, i.e., information can be embedded with little quality (image quality) deterioration of source digital information (quality). The second condition is that information embedded in digital information remains unerased, i.e., embedded information is not lost by edit and attack such as data compression, filter process, and the like (robustness). The third condition is that the information volume of information that can be embedded can be selected in accordance with the purpose intended (information volume). These conditions required for digital watermarking normally have a trade-off relationship. For example, upon implementing robust digital watermarking, relatively serious quality deterioration occurs, and the information volume that can be embedded normally decreases.

Taking a multi-valued still image as an example, the method of embedding a digital watermark is roughly classified into a method of embedding in the spatial domain, and a method of embedding in the frequency domain, and the following various methods are known.

Examples of the method of embedding in the spatial domain include an IBM scheme (W. Bender, D. Gruhl, & N. Morimoto, “Techniques for Data Hiding”, Proceedings of the SPIE, San Jose Calif., USA, February 1995), G. B. Rhoads & W. Linn, “Steganography methods employing embedded”, U.S. Pat. No. 5,636,292, and the like, which employ patchwork.

Examples of the method of embedding in the frequency domain include an NTT scheme (Nakamura, Ogawa, & Takashima, “A Method of Watermarking under Frequency Domain for Protecting Copyright of Digital Image”, SCIS' 97-26A, January 1997), which exploits discrete cosine transformation, a scheme of National Defense Academy of Japan (Ohnishi, Oka, & Matsui, “A Watermarking Scheme to Image Data by PN Sequence”, SCIS' 97-26B, January 1997) which exploits discrete Fourier transformation, and a scheme of Mitsubishi and Kyushu University (Ishizuka, Sakai, & Sakurai, “On an Experimental Evaluation of Steganography with Wavelet Transform”, SCIS' 97-26D, January 1997) and a Matsushita scheme (Inoue, Miyazaki, Yamamoto, & Katsura, “A Digital Watermark Technique based on the Wavelet Transform and its Robustness on Image Compression and Transformation”, SCIS' 98-3.2.A, January 1998) which last two exploit discrete wavelet transformation, and the like.

However, the aforementioned conventional digital watermarking schemes have nearly no robustness against technical attacks to be described below. For example, when identical images embedded with watermark information which differs for respective users are distributed, the watermark embedded can be partially detected based on a difference by comparing a plurality of images with watermark information (such technical attack is called an alliance attack). If the detected difference information is erased or tampered with, the watermark information itself is erased or tampered with, and the person responsible for that act cannot be specified if he or she illegally distributes digital images (especially, if watermark information of another person can be detected by analogy from the difference information, that person may be wrongfully accused of the crime by modifying that information). This can be conceptually described by the following equation. If A represents an original image, and Wi represents digital watermark information to be embedded in that image for user i (i =1, 2, . . . , n), a digitally watermarked image Gi to be distributed to user i can be described by:
Gi=A+Wi (1)
for Wi<<A since the digital watermark information is a very small level variation with respect to an original signal level.

When users j, k, and m compare their digitally watermarked images Gj, Gk, and Gm in alliance with one another, and determine to generate an image Gx obtained by adding the difference between Gj and Gk to Gm, the image Gm is given by:
Gx=Gm+(Gj−Gk)=A+Wm+Wj−Wk=A+Wx (2)

This image Gx is equivalent to an image obtained by embedding tampered watermark information Wx=Wm+Wj−Wk(Wx<<A) in the original image A, and this watermark information is different from those distributed to users j, k, and m. For this reason, if users j, k, and m illegally distribute this image Gx, it is impossible to specify them.

Alliance attack can be attained by an alliance of a few users as in the above example. However, watermark information can be tampered with but it is difficult that watermark information is completely erased from an image in which it is embedded. By contrast, when many users enter into an alliance with one another or a given user collects many identical images embedded with different digital watermark information, watermark information, a small change in image information, can be nearly perfectly erased by computing the average value of these images. Such attack is based on the fact that watermark information Wi is a random-number signal, and becomes 0 if an average of a plurality of pieces of watermark information is calculated. This attack is called an average value attack. Let G be an image obtained by the average value attack, and ΣWi/n=0 (i=1, 2, . . . , n) be the average value of watermark information. Then, the equation below illustrates that the image G becomes equal to the original image A:
G=ΣGi/n=(ΣA+ΣWi)/n=A+ΣWi/n=A (3)

Therefore, the present invention has been made in consideration of the aforementioned problems, and has as its object to protect original data from being tampered with by embedding a digital watermark which is robust against the aforementioned alliance attack and average value attack.

### SUMMARY OF THE INVENTION

In order to achieve the object of the present invention, for example, an image processing apparatus of the present invention comprises the following arrangement.

That is, an image processing apparatus comprises generation means for generating digital data which comprises a first data group required to maintain basic quality of the digital data, and a second data group required to maintain detailed quality, change means for changing the second data group in the digital data, and embedding means for embedding a digital watermark in the image which contains the changed second data group.

In order to achieve the object of the present invention, for example, an image processing apparatus of the present invention comprises the following arrangement.

That is, an image processing apparatus for embedding a digital watermark in an image, comprises setting means for setting a range of frequency components to be changed of frequency components of the image, and change means for changing at least one of the frequency components included in the range of the frequency components to be changed, wherein the digital watermark is embedded in the image which contains the frequency component changed by the change means.

The apparatus further comprises frequency component calculation means for calculating frequency components of the image, and image generation means for generating an image from frequency components of the image including the frequency component changed by the change means.

In order to achieve the object of the present invention, for example, an image processing apparatus of the present invention comprises the following arrangement.

That is, an image processing apparatus for embedding a digital watermark in an image, comprises setting means for setting a range of bits to be changed of a plurality of bits which form a multi-valued pixel upon expressing pixels which form the image using multi-valued data, and change means for changing at least one of bits included in the range of bits to be changed, wherein the digital watermark is embedded in the image which includes the bit changed by the change means.

In order to achieve the object of the present invention, for example, an image processing apparatus of the present invention also comprises the following arrangement.

That is, an image processing apparatus for embedding a digital watermark in an image, comprises generation means for segmenting pixels which form the image into blocks, and generating an average value image having average pixel values of pixels included in the blocks, and change means for changing a value of at least one pixel of pixels included in each block, wherein the digital watermark is embedded in an image including the pixel, the value of which is changed by the change means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic diagram showing an arrangement of a process upon computing the wavelet transforms;

FIG. 2 is a schematic view showing subbands generated by wavelet transformation;

FIG. 3 is a flow chart of a change process for an original image by an image processing apparatus according to the first embodiment of the present invention;

FIG. 4 is a view for explaining a change process for the original image by an image processing apparatus according to the first embodiment of the present invention;

FIG. 5 shows digitally watermarked images which have undergone different modifications for respective users in the first embodiment of the present invention;

FIG. 6 is a diagram showing a general flow of a digital watermarking process in the first embodiment of the present invention;

FIG. 7 is a schematic block diagram showing a arrangement of an image processing apparatus in the first embodiment of the present invention;

FIG. 8 shows decomposed frequency components;

FIG. 9 is a view for explaining a multi-valued image;

FIG. 10 is a flow chart showing a modification process for an original image in the third embodiment of the present invention;

FIG. 11A shows an image made up of 32×32 pixels;

FIG. 11B shows an average value image obtained by calculating average values in units of 4×4 pixels of the image shown in FIG. 11A;

FIG. 12A shows pixel values in one block;

FIG. 12B shows pixel values in one block;

FIG. 12C shows pixel values in one block; and

FIG. 12D shows pixel values in one block.

### DETAILED DESCRIPTION OF THE PREFERRED EMBODIMENTS

Preferred embodiment of the present invention will now be described in detail in accordance with the accompanying drawings.

### First Embodiment

According to this embodiment, a digital watermark is embedded in an original image in the following sequence. An image of given image quality (relatively low image quality) which may be acquired by attackers of the alliance attack or average value attack is determined with respect to an original image, and an image having image quality higher than the given image quality is changed for each user. After the change, a digital watermark is embedded.

The aforementioned sequence can be conceptually described by the following equations.

Assuming that an original image A is obtained by compositing a low-image quality component AO and high-image quality component B, the image A is described by:
A=A0+B (4)

If Bi represents a high-image quality component obtained by changing the high-image quality component B for user i (i=1, 2, . . . , n), a modified image Ai for user i is expressed by:
Ai=A0+Bi (5)

Since Bi is a high-image quality component, i.e., a high-frequency component, its slight variation cannot be perceived by the human eye.

A digitally watermarked image Gi obtained by embedding a digital watermark Wi in the modified image Ai for user i is given by:
Gi=A0+Bi+Wi (6)

When this image Gi suffers an alliance attack as in the prior art, the image obtained is:

$$\begin{matrix}Gx = Gm + ( Gj - Gk ) \\ = A 0 + ( Bm + Bj - Bk ) + ( Wm + Wj - Wk ) \\ = A 0 + Bx + Wx\end{matrix} \qquad ( 7 )$$

Since Bm, Bj, and Bk are high-frequency components obtained by modifying Bi to be different from one another, and the signal level is normally not smaller than a signal for digital watermark information, a composite signal Bx of these high-frequency components becomes a noise signal. Hence, Gx is a composite image obtained by compositing the noise component Bx and digital watermark information Wx to the low-image quality image A0. Although the digital watermark information Wx contained in the composite image Gx has been tampered with, the image quality of the composite image Gx is equivalent to that of the sum of the low-image quality component A0 and the noise component Bx. Hence, the image quality of this composite image Gx is equal to or lower than that of A0, and deteriorates larger than that of a composite image obtained by the alliance attack described in the prior art.

Against an average value attack, the following image is obtained. In general, an average value ΣBi/n of different high-frequency components is considered as a noise component.

$$\begin{matrix}G = Σ Gi / n = Σ A 0 / n + Σ Bi / n + Σ Wi / n \\ = A 0 + Σ Bi / n\end{matrix} \qquad ( 8 )$$

Hence, a composite image G obtained by an average value attack is an image obtained by adding the noise component ΣBi/n to the low-image quality image A0, and its image quality is equal to or lower than that of A0 as in the alliance attack. Hence, the obtained image suffers larger image quality deterioration than that of a composite image obtained by the average value attack described in the prior art.

Since an image in which a digital watermark is embedded by the aforementioned method lowers its image quality as it repetitively receives, e.g., an alliance attack, it is impossible to generate an image in which only source digital watermark information has been changed while maintaining the original image quality.

On the other hand, even when an image in which a digital watermark is embedded by the aforementioned method receives, e.g., an average value attack, the original image cannot be obtained.

An example of a digital watermarking process of this embodiment using discrete wavelet transformation will be explained below.

Wavelet transformation will be explained first. Wavelet transformation decomposes input multi-valued image data into a predetermined number of frequency bands (to be referred to as subbands hereinafter), as will be described later.

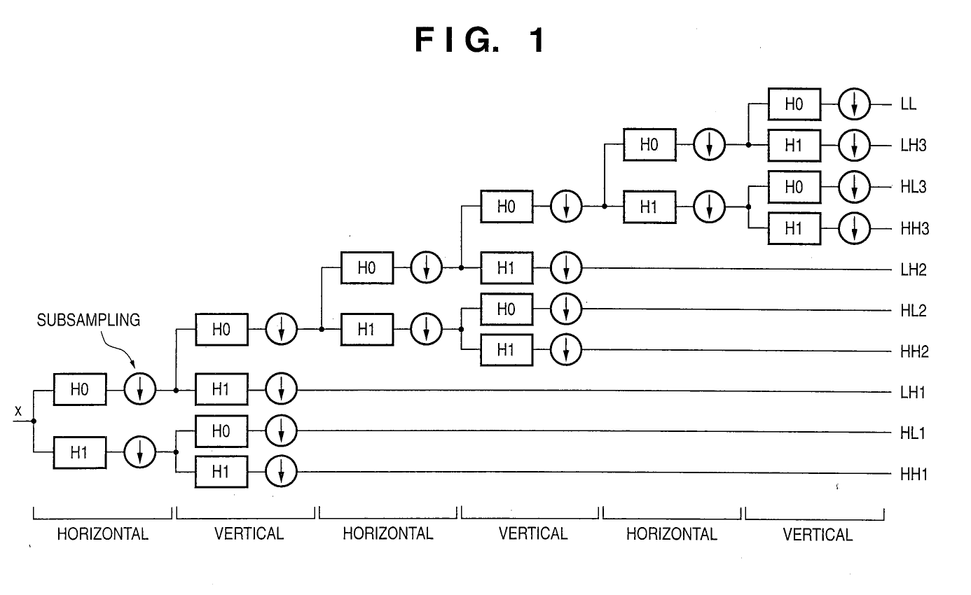

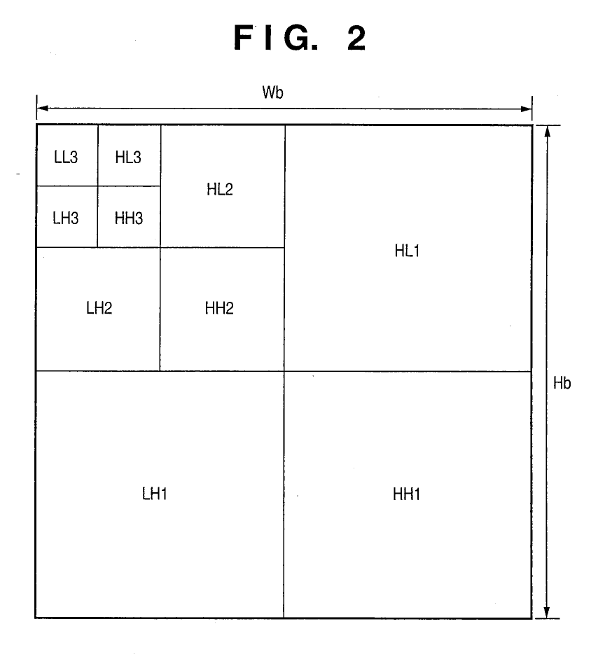

FIG. 1 is a schematic diagram showing the arrangement of a process upon computing the wavelet transforms, and FIG. 2 is a schematic view of subbands obtained by the process (wavelet transformation) of this arrangement.

Referring to FIG. 1, input multi-valued image data x is filtered by low-pass filters H0 or high-pass filters H1 in the horizontal and vertical directions, and is subsampled every time it is filtered by a given filter. As a result, the input multi-value image data x is decomposed into a plurality of frequency bands.

FIG. 2 shows the processing result obtained when multi-valued image data having Wb pixels in the horizontal direction and Hb pixels in the vertical direction has undergone three transformation steps shown in FIG. 1. Note that one transformation step is done when the transforms of a predetermined region of an original image are computed once using the low- and high-pass filters in the horizontal and vertical directions.

The size of a block shown in FIG. 2 corresponds to that (Wb×Hb) of a unit image (block image) to be processed in this embodiment.

For example, a result r of the multi-valued image data x that has undergone the low-pass filter process and subsampling and a result d of the multi-valued image x data that has undergone the high-pass filter process and subsampling are respectively described by:

$$\begin{matrix}r ( n ) = [ ( X ( 2 n ) + x ( 2 n + 1 ) ) / 2 ] & ( 9 ) \\ d ( n ) = x ( 2 n + 2 ) - x ( 2 n + 3 ) + [ ( - r ( n ) + r ( n + 2 ) + 2 ) / 4 ] & ( 10 )\end{matrix}$$

where [x] is a maximum integer smaller than x. The wavelet transformation process of the arrangement shown in FIG. 1 sequentially repeats the filter process and subsampling in the horizontal and vertical direction in this way, and decomposes each block image into a plurality of subbands.

FIG. 2 shows the names of subbands obtained by the aforementioned wavelet transformation process shown in FIG. 1, and the spatial positional relationship among those subbands. Each subband contains a corresponding transformation coefficient (frequency component). Referring to FIG. 2, LL3 is a region containing the lowest frequency component, and corresponds to an image having the lowest image quality. LH3, HL3, and HH3, and LH2, HL2, and HH2 are the second and third lowest frequency regions compared to LL3. Finally, LH1, HL1, and HH1 are regions containing the highest frequency components.

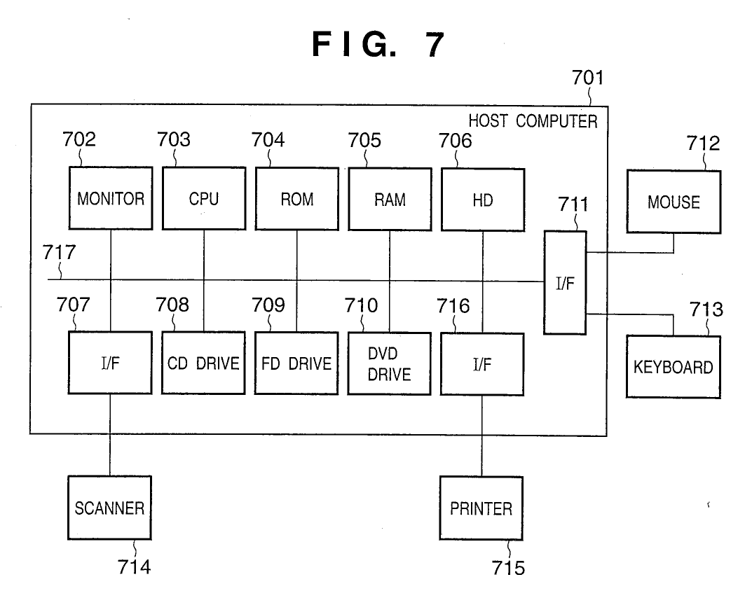

FIG. 7 is a schematic block diagram showing the arrangement of an image processing apparatus of this embodiment which can implement the aforementioned digital watermarking.

Referring to FIG. 7, a host computer 701 is, for example, a general personal computer, and can receive, edit, and save an image scanned by a scanner 714. Furthermore, the host computer 701 can control a printer 715 to print the obtained image. The user inputs various manual instructions and the like using a mouse 712 and keyboard 713.

In the host computer 701, respective blocks to be described below are connected via a bus 717, and can exchange various data.

In FIG. 7, reference numeral 703 denotes a CPU which can control the operations of respective internal blocks, or can execute programs stored in a ROM 704, RAM 705, and the like.

Reference numeral 704 denotes a ROM for storing a specific image which is inhibited from being printed, and pre-storing a required image processing program and the like.

Reference numeral 705 denotes a RAM for temporarily storing a program and image data to be processed upon executing a process by the CPU.

Reference numeral 706 denotes a hard disk (HD) which can pre-store a program and image data to be transferred to the RAM 705 or the like, and can save processed image data.

Reference numeral 707 denotes a scanner interface (I/F) for connecting an external CCD or scanner 714 for generating and receiving image data from a document, film, or the like.

Reference numeral 708 denotes a CD drive which can read or write data from or in a CD (CD-R) as one of external storage media.

Reference numeral 709 denotes an FD drive which can read or write data from or in a floppy disk (FD) as in the CD drive 708. Reference numeral 710 denotes a DVD drive which can read or write data from or in a DVD.

When the CD, FD, DVD, and the like store an image edit program or printer driver, such programs are installed from the corresponding drives on the HD 706, and are transferred to the RAM 705 as needed.

Reference numeral 711 denotes an interface (I/F) connected to the mouse 712 or keyboard 713 to receive an input instruction therefrom.

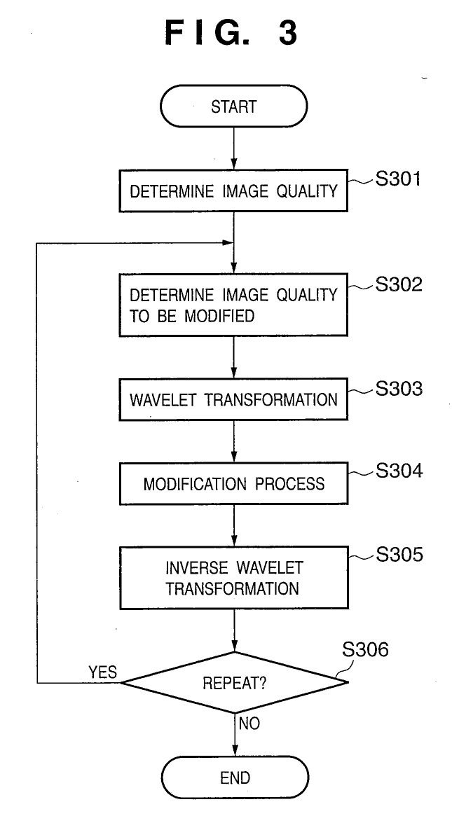

A change process for an original image done by the image processing apparatus with the above arrangement (before the digital watermarking process) will be described below with reference to the flow chart in FIG. 3. Assume that an original image is read from the scanner 714, or one of the drives (CD drive 708, FD drive 709, and DVD drive 710), and is broken up into blocks by a program code stored in the RAM 705 before execution of the process according to this flow chart. Each block image serves as an image to be processed in the following description.

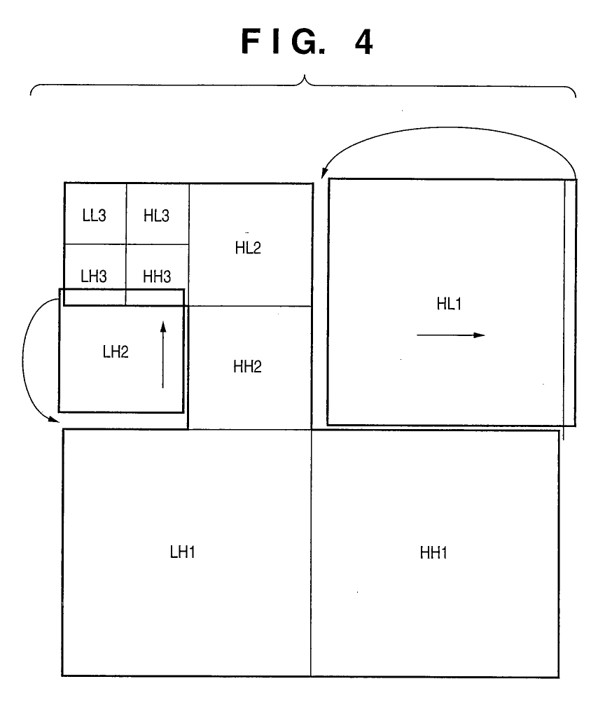

Initially, image quality that may be obtained by an attacker by, e.g., an alliance attack is determined (step S301) . In this case, LL3 is determined to be that image quality. Hence, LH3 to HH1 other than LL3 are determined as high-image quality portions (components) which are used to generate an image with higher image quality than LL3. A portion to be modified is determined from the high-image quality portions, and is designated using the mouse 712 or keyboard 713 (step S302). In this case, HL1 is determined to be a high-image quality portion to be modified, and is entirely shifted rightward by 1 bit. Hence, prepared block images undergo wavelet transformation (step S303) to be decomposed into frequency components shown in FIG. 2, and HL1 as the selected high-image quality portion is modified, as shown in FIG. 4 (step S304). Note that the right end bits of HL1 that overflow upon modification may be inserted in blanks at the left end of HL1, as shown in FIG. 4, or the right end bits may be discarded, and the left end bits of HL1 may be copied to blanks at the left end. Upon completion of the aforementioned modification process, this block undergoes inverse wavelet transformation to reclaim the block image (step S305). In this block image, image quality corresponding to the frequency component HL1 has been modified by the process in step S304.

It is determined if the aforementioned process is to be repeated (step S306). That is, it is determined if a frequency band corresponding to another image quality to be modified is determined and modified. If it is determined that the aforementioned process is to be repeated, the flow returns to step S302 of determining a portion to be modified from the high-image quality portions. In this case, assume HL2 is selected as a high-image quality portion to be modified, and is entirely shifted upward by 1 bit. As a result, wavelet transformation is made in the same manner as in the above process, and HL2 undergoes the determined modification. It is checked in step S306 again if the process is to be repeated. If NO in step S306, the processing ends.

In the above modification examples, HL1 is shifted rightward by 1 bits, and HL2 is shifted upward by 1 bit. However, the bit shift directions and amounts are not limited to such specific examples. If four arithmetic operations of amplitudes of pixels in each frequency component are included, numerous combinations of modifications may be made. A modification scheme may be selected based on a random function or the like or in association with a user ID or the like. The wavelet transforms of block images may be initially computed once in place of being computed before every modification process, and the inverse wavelet transforms may be finally computed after it is determined in step S306 that the process is not to be repeated.

Upon completion of the aforementioned process, a digital watermark is embedded in the changed image.

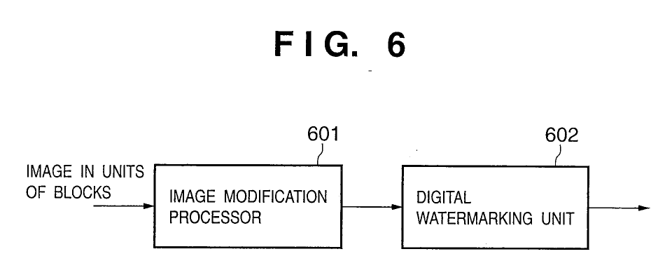

FIG. 6 shows the general flow of the digital watermarking process in this embodiment. Reference numeral 601 denotes an image modification processor which modifies a high-image quality component B of a block image to be processed to Bi to generate a modified image Ai given by equation (5). Reference numeral 602 denotes a digital watermarking unit for embedding digital watermark information Wi in an image to generate a digitally watermarked image Gi given by equation (6). The digital watermarking process may use various schemes such as the aforementioned schemes for embedding in the frequency domain, schemes for embedding in the spatial domain, and the like. Since the digital watermarking unit can share a wavelet transformer and inverse transformer with the image modification processor, wavelet transformation may be executed once before the image modification processor, and inverse wavelet transformation may be executed once after digital watermarking.

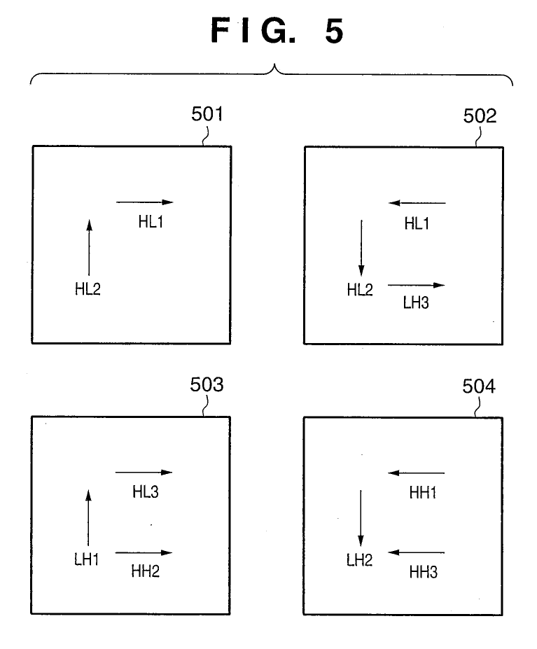

FIG. 5 shows digitally watermarked images which are obtained by the process shown in FIG. 6, and have undergone different modifications in units of users. Reference numeral 501 denotes the aforementioned image in which HL1 and HL2 are respectively shifted rightward and upward; 502, an image in which HL1, HL2, and LH3 are respectively shifted leftward, downward, and rightward; 503, an image in which LH1, HL3, and HH2 are respectively shifted upward, rightward, and rightward; and 504, an image in which LH2, HH1, and HH3 are respectively shifted downward, leftward, and leftward. Upon comparing the alliance attack results of these images (501 to 504), since all images have different portions having image quality higher than LL3, an image having image quality equal to or lower than LL3 can only be obtained, as can be seen from the description of equation (7). Furthermore, even when the average value of the respective images is computed by an average value attack, portions having image quality higher than LL3 are lost since they are different from each other, and only an image having image quality equal to or lower than LL3 can only be obtained, as can be seen from equation (8).

As described above, according to the image processing apparatus and method of this embodiment, digital watermark information can be prevented from being tampered with even by an alliance attack, and an original image cannot be obtained by an average value attack. As a result, source data (original image) can be protected from being tampered with.

### Second Embodiment

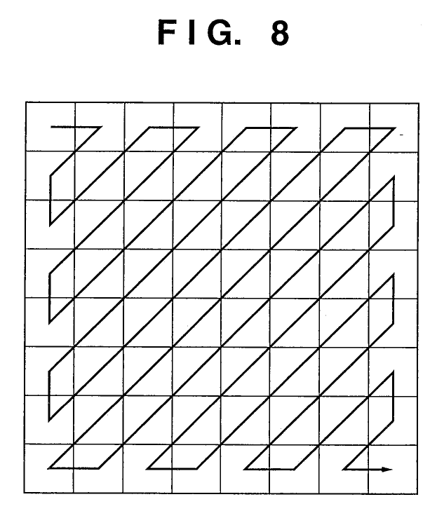

In the first embodiment, wavelet transformation is used upon computing the frequency transforms of block images. In this second embodiment, discrete cosine transformation is used as a frequency transformation method in place of wavelet transformation. When discrete cosine transformation is used in place of wavelet transformation, frequency components are also decomposed from higher- to lower-frequency components by discrete cosine transformation. FIG. 8 shows decomposed frequency components. In FIG. 8, an upper left pixel corresponds to the lowest frequency component, and pixels corresponding to higher-frequency components appear in the direction of the arrow.

The change process for an original image in this embodiment is executed according to a flow chart in which the processes in the respective steps of the flow chart shown in FIG. 3 are modified as follows.

In step S301, for example, lower-frequency components equal to or lower than the 32nd frequency in the direction of the arrow in FIG. 8 are determined to specify image quality that may be obtained by an attacker. In step S302, for example, higher-frequency components after the 33rd frequency in the direction of the arrow in FIG. 8 are determined to specify the image quality of an image to be modified. In step S303, discrete cosine transformation is executed. In step S304, a predetermined value is subtracted from the 33rd frequency component. In step S305, inverse discrete cosine transformation is executed. It is checked in step S306 if the process executed for the 33rd frequency component is also executed for the next frequency component (34th frequency component in this case).

With the process according to the flow chart described above, the change process for an original image in this embodiment can be implemented. Upon completion of the process according to the flow chart of this embodiment, a digital watermarking process is executed.

In the above modification example, a given value is subtracted from the frequency component. Alternatively, another process such as quantization or the like may be executed. Also, the value to be subtracted from each frequency component may be selected using a random function or the like or in association with a user ID or the like. Thus, numerous combinations of modifications may be made. As in the first embodiment, after image modification, digital watermarking in 602 in FIG. 6 is done.

As can be seen from equations (7) and (8), when the aforementioned process is executed while selecting different values for respective users, since the 33rd and higher frequency components have random values in images for respective users, a low-image quality image can only be obtained even by an alliance attack, average value attack.

As described above, according to the image processing apparatus and method of this embodiment, digital watermark information which is robust against alliance and average value attacks can be embedded irrespective of the types of frequency transformation as in the first embodiment, and source data (original image) can be protected from being tampered with.

### Third Embodiment

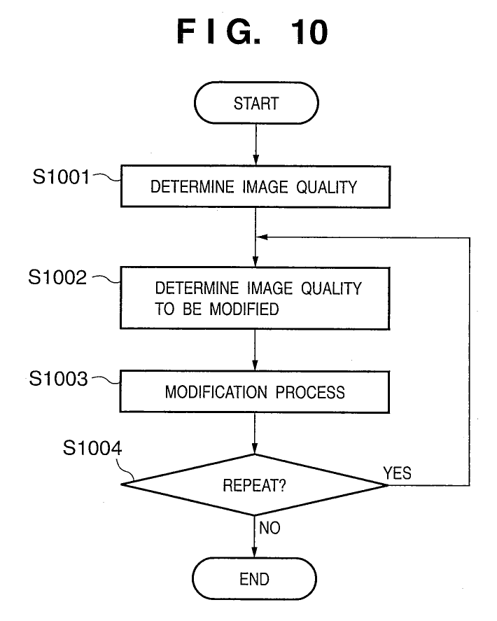

In the first and second embodiments described above, block images temporarily undergo orthogonal transformation, and the aforementioned change process is done for the transformed image in the frequency domain. However, in this third embodiment, pixels on an actual image space directly undergo the change process. This process will be explained below with reference to FIG. 10 which is a flow chart showing the process of this embodiment.

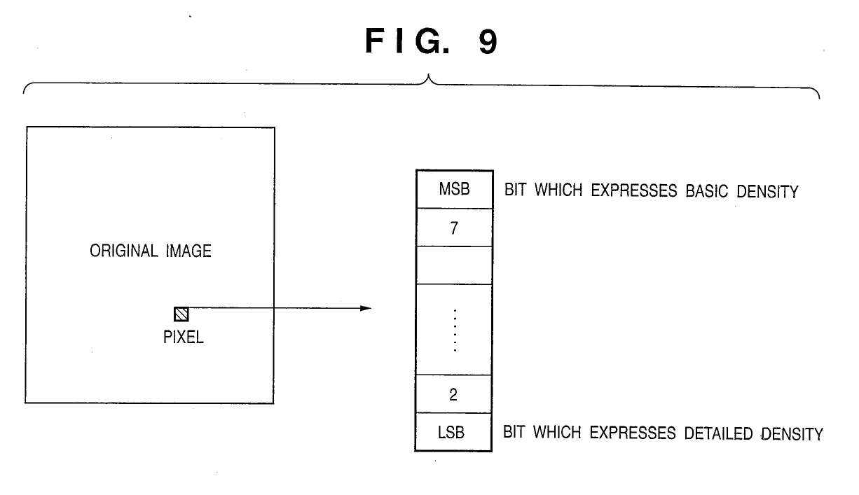

In a multi-valued image, each pixel consists of a plurality of bits from the MSB to LSB, as shown in FIG. 9. The MSB corresponds to a bit that represents the basic density of the image, and bits toward the LSB gradually express detailed density levels of the image. In this embodiment, assume that one pixel consists of 8 bits, and the image quality defined by the MSB (first bit) to the 4th bit in FIG. 9 is determined to be that which may be obtained by an attacker by, e.g., an alliance attack (step S1001 in FIG. 10). Hence, the 5th bit to the LSB correspond to high-image quality portions which are used to generate a high-image quality image. A portion to be modified of the high-image quality portions is determined (step S1002). In this embodiment, the 6th bit of a given pixel is inverted as a high-image quality portion to be modified described in the above embodiments (step S1003). It is determined if the process is to be repeated (step S1004) . If the process is to be repeated, the flow returns to step S1002 of determining a portion to be modified of high-image quality portions. In this embodiment, the same process is repeated for some bits and pixels. Upon completion of modification of scheduled pixels, the processing ends.

In the above description, one bit of each selected pixel is inverted. Alternatively, a process for subtracting a given value from a pixel value may be done. A pixel value and process may be selected using a random function or the like or in association with a user ID or the like, thus allowing numerous combinations of modifications. After the aforementioned image deformation, a digital watermark is embedded as in the first and second embodiments.

As a result, when the aforementioned process is done by selecting different bits for respective users, since the 5th bit to the LSB have random values for respective users, only a low-image quality image can be obtained by an alliance attack or average value attack, as can be seen from equations (7) and (8).

As described above, in this embodiment, since the aforementioned change process is directly done for pixels in place of orthogonal transformation coefficients, an image robust against alliance and average value attacks can be generated as in the first and second embodiments.

### Fourth Embodiment

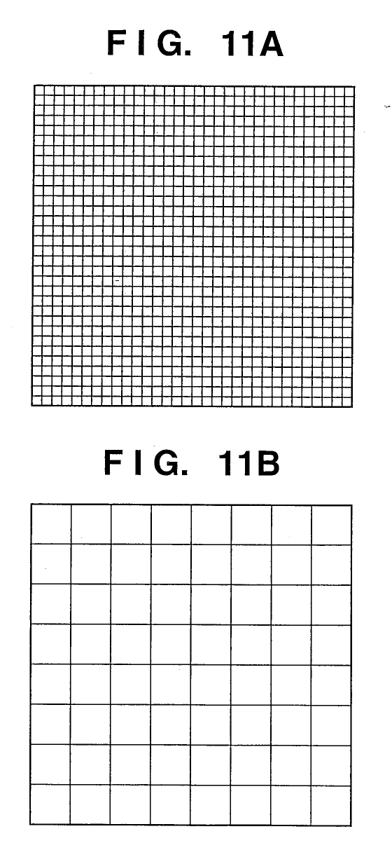

FIG. 11A shows an original image consisting of 32×32 pixels, and FIG. 11B shows an average value image obtained by calculating average values in units of 4×4 pixels. Also, the image shown in FIG. 11B is determined to be a low-image quality image which may be acquired by an attacker. In this case, pixels in 4×4 blocks are modified for respective users to define a normal distribution having their average values as the center, and the modified images are distributed to the respective users.

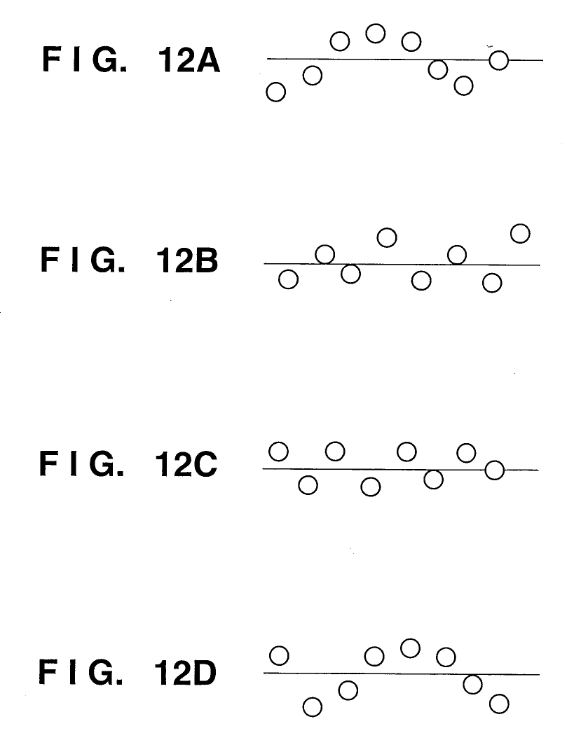

For example, points shown in FIGS. 12A to 12D show pixel values in one block (expressed by 8 points for the sake of simplicity), and a line expresses the average value of that block. When pixels of an original image shown in FIG. 12A are modified, as shown in FIGS. 12B to 12D, the modified blocks assume the same average value but are different from each other. When these blocks undergo an average value attack, respective pixels assume the average value. Hence, when respective blocks shown in FIG. 11A are modified for respective users to define a normal distribution having their average values as the center, and the modified images are distributed to the respective users, apparently attackers of an alliance attack can only acquire the average value image shown in FIG. 11B.

This embodiment has exemplified a case wherein an image consisting of 32×32 pixels is broken up into 4×4 blocks. However, the number of pixels is not particularly limited, and the present invention is effective for a case wherein an M×N image is broken up into m×n blocks.

Therefore, the implementation sequence is the same as that shown in FIG. 10. More specifically, average values are calculated in units of pixel blocks, and image quality that may be acquired by an attacker by, e.g., an alliance attack or the like is determined (step S1001). Hence, differences between respective pixel values and the average values specify high-image quality portions which are used to generate a high-image quality image. Then, a portion to be modified of the high-image quality portions is determined (step S1002). In this case, an arbitrary block of the segmented image may be selected, or a block to be modified may be selected in accordance with ID information, key information, or the like for each user. Respective pixels are modified for respective users to have a normal distribution having the average values as the center (step S1003). It is determined if the process is to be repeated (step S1004). If the process is to be repeated, the flow returns to step S1002 of determining a portion to be modified of high-image quality portions. Upon completion of modification of scheduled pixels, the processing ends.

The image is not limited to an image on the spatial domain but may be an image on the frequency domain. For example, an image that has undergone wavelet transformation shown in FIG. 2 can be changed by segmenting and shifting values in each frequency component or changing values to have an average value as the center in place of the process in units of frequency components.

As described above, this embodiment can be implemented irrespective of the types of frequency transformation or spatial processe. Furthermore, image modifications using frequency and space can be combined.

### Fifth Embodiment

In the first to fourth embodiments, an image has been explained as an object in which a digital watermark is to be embedded. However, the present invention is not limited to digital watermarking for an image, but is also effective for various other data such as moving image data, text data, audio data, and the like.

Also, information to be embedded includes various data such as encrypted data, compression-coded data, and the like in addition to ASCII codes, or the like.

Note that the present invention is not limited to the above embodiments. That is, the principle of the present invention includes an arrangement in which digital (image) data to be processed comprises a first data group required to hold basic quality (image quality) and a second data group required to maintain detailed quality (image quality), and a digital watermark is embedded after the second data group undergoes various changes (changes in meaning originally expressed by the second data group) mentioned above.

### Other Embodiments

The present invention is not limited to only the apparatus and method for implementing the aforementioned embodiments, and a method implemented as a combination of the methods described in the embodiments, but the scope of the present invention includes a case wherein the above embodiments are achieved by supplying a program code of software that can implement the functions of the above-mentioned embodiments to a computer (or a CPU or MPU) in a system or apparatus, and making the computer control various devices in the system or apparatus.

In this case, the program code itself read out from the storage medium implements the functions of the above-mentioned embodiments, and the program code itself, and means for supplying the program code to the computer (i.e., a storage medium which stores the program code) are included in the scope of the present invention.

As the storage medium for storing such program code, for example, a floppy disk, hard disk, optical disk, magneto-optical disk, CD-ROM, magnetic tape, nonvolatile memory card, ROM, and the like may be used.

The program code is included in the scope of the embodiments not only when the functions of the above embodiments are implemented by controlling various devices according to the supplied program code alone but also when the functions of the embodiments are implemented by collaboration of the program code and an OS (operating system) or another application software running on the computer.

Furthermore, the scope of the present invention includes a case wherein the functions of the above-mentioned embodiments are implemented by some or all of actual processing operations executed by a CPU or the like arranged in a function extension board or a function extension unit, which is inserted in or connected to the computer, after the supplied program code is written in a memory of the extension board or unit.

When the present invention is applied to the aforementioned storage medium, the storage medium stores program codes according to the flow chart shown in FIG. 3 or 10, or the flow chart described in the second embodiment.

As can be seen from the above description, the present invention can embed a digital watermark which is robust against alliance and average value attacks, and can protect original data from being tampered with.

As many apparently widely different embodiments of the present invention can be made without departing from the spirit and scope thereof, it is to be understood that the invention is not limited to the specific embodiments thereof except as defined in the appended claims.

1-5. (canceled)

6. An image processing apparatus for embedding a digital watermark in an image, comprising:
setting means for setting a range of bits to be changed of a plurality of bits which form a multi-valued pixel upon expressing pixels which form the image using multi-valued data; and
change means for changing at least one of bits included in the range of bits to be changed,
wherein the digital watermark is embedded in the image which includes the bit changed by said change means; and
wherein said change means changes for respective users.

7. (canceled)

8. The apparatus according to claim 6, wherein a change process of said change means includes processes of four arithmetic operations.

9. The apparatus according to claim 6, wherein a change process of said change means includes bit inversion.

10-14. (canceled)

15. An image processing method for embedding a digital watermark in an image, comprising:
the setting step of setting a range of bits to be changed of a plurality of bits which form a multi-valued pixel upon expressing pixels which form the image using multi-valued data; and
the change step of changing at least one of bits included in the range of bits to be changed,
wherein the digital watermark is embedded in the image which includes the bit changed in the change step; and
wherein said change step changes for respective users.

16-18. (canceled)

19. A storage medium that stores a program code which serves as an image processing apparatus for embedding a digital watermark in an image, comprising:
a program code of the setting step of setting a range of bits to be changed of a plurality of bits which form a multi-valued pixel upon expressing pixels which form the image using multi-valued data; and
a program code of the change step of changing at least one of bits included in the range of bits to be changed,
wherein the digital watermark is embedded in the image which includes the bit changed in the change step; and
wherein said change step changes for respective users.

20-28. (canceled)

29. The method according to claim 15, wherein a change process of said change step includes processes of four arithmetic operations.

30. The method according to claim 15, wherein a change process of said change step includes bit inversion.

31. The method according to claim 19, wherein a change process of said change step includes processes of four arithmetic operations.

32. The storage medium according to claim 19, wherein a change process of said change step includes bit inversion.
